(19) United States
(12) Patent Application Publication
(10) Pub. No.: US 2011/0206397 A1
(43) Pub. Date: Aug. 25, 2011

(54) IMAGE FORMING APPARATUS AND IMAGE FORMING METHOD

(75) Inventors: Naotaka HIGUCHI, Suwa-gun (JP); Yoshitomo HIRATA, Azumino-shi (JP)

(73) Assignee: SEIKO EPSON CORPORATION, Tokyo (JP)

(21) Appl. No.: 13/027,526

(22) Filed: Feb. 15, 2011

(30) Foreign Application Priority Data
Feb. 24, 2010 (JP) 2010-038176

(51) Int. Cl. G03G 15/00; G03G 15/10

(52) U.S. Cl. 399/49; 399/57; 399/249; 399/55

(57) ABSTRACT

An image forming apparatus comprising a latent image carrier for supporting a latent image, a charging unit for charging the latent image carrier, a developing unit for developing the latent image supported by the latent image carrier which has a developing member for supporting a liquid developer containing a toner and a carrier liquid, and to which a developing bias is applied, a first optical density detector for detecting the toner optical density in the liquid developer supported by the latent image carrier developed by the developing member, a squeeze unit for squeezing the latent image carrier which has a squeeze member brought into contact with the latent image carrier for which toner optical density has been detected by the first optical density detector, and a second optical density detector for detecting the toner optical density of the liquid developer supported by the latent image carrier squeezed by the squeeze member.

### CROSS-REFERENCE TO RELATED APPLICATIONS

This application claims priority to Japanese Patent Application No. 2010-038176 filed on Feb. 24, 2010. The entire disclosure of Japanese Patent Application No. 2010-038176 is hereby incorporated herein by reference.

### BACKGROUND

2. Technical Field

The present invention relates to an electrophotographic image forming apparatus and image forming method in which developing is performed using a liquid developer containing a toner and a carrier liquid, and in which the carrier liquid supported by a latent image carrier is squeezed after development.

2. Background Technology

In an image forming apparatus using a liquid developer containing a toner and a carrier liquid, the excess carrier liquid from the liquid developer developed on the latent image carrier has to be removed. Also, the excess toner (fogging toner) particles attached to the non-image portion of the latent image carrier has to be removed. Therefore, it has been proposed that excess developer, including excess carrier liquid and fogging toner particles, be removed using a removing member (squeeze member) which rotatably makes contact with the latent image carrier in the direction opposite that of the rotational direction of the latent image carrier (the direction of both circumferential velocities being the same) (referred to as “rotating with each other” below) (see, for example Patent Citation 1 and Patent Citation 2).

Also, as described in Patent Citation 2, the toner optical density of the toner image on the latent image carrier is detected by an optical density sensor after passing the excess developer removal unit, and the bias applied to the removing member or the nip width between the latent image carrier and the removing member is adjusted based on the detection results to control the removal force. Image quality can be maintained despite changes in the imaging conditioned by controlling this removal force.

Japanese Patent Application Publication No. 2002-278303 (Patent Citation 1) is an example of the related art.

Japanese Patent Application Publication No. 2006-189639 (Patent Citation 2) is an example of the related art.

### SUMMARY

### Problems to Be Solved by the Invention

However, when the removing member makes rotatable contact with the latent image carrier as described in Patent Citation 1 and Patent Citation 2, a liquid pool (meniscus) forms at the nip entrance between the removing member and the latent image carrier. In particular, a liquid pool readily forms when the peripheral velocity of the latent image carrier is substantially equal to the circumferential velocity of the removing member. This liquid pool often retains toner particles from the fogging toner that has moved from the non-image portion of the latent image carrier. When the image portion of the latent image carrier reaches the nip entrance described above, the toner particles move to the latent image carrier side and become re-attached to the image portion (re-development). When redevelopment occurs, the optical density becomes irregular; i.e., the optical density at the front end of the image portion is higher than the optical density at the rear end, and the uniformity of image quality deteriorates.

Also, because the bias of the removing member (e.g., 300 V) is higher than the electric potential (e.g., 50 V) of the image portion of the latent image carrier even when the bias of the removing member is controlled as described in Patent Citation 2, an electric field is generated from the removing member side to the image portion side. As a result, fogging toner is re-developed in the image portion. Furthermore, as described in Patent Citation 2, a liquid pool forms as long as a nip is formed, even when the nip width between the removing member and the latent image carrier is controlled. This makes it difficult to eliminate the re-development of fogging toner. Moreover, while the removal force of the removing member is controlled in response to changes in the optical density of an image pattern, it is difficult to eliminate the re-development of fogging toner even with removal force control because optical density changes occur within the image pattern.

In view of such circumstances, an advantage of some aspects of the invention is to provide an image forming apparatus and an image forming method which is able to control the movement of toner particles from the squeeze member to the latent image carrier even when a liquid pool forms at the entrance to the squeeze nip, and which is able to ensure uniform or nearly uniform image density across all areas of the image.

### Means Used to Solve the Above-Mentioned Problems

In order to solve the problem mentioned above, according to the image forming apparatus and image forming method of the invention, a latent image supported by a latent image carrier is developed using a liquid developer including a toner and a carrier liquid, the liquid developer being supported by a developing member to which a developing bias has been applied. The toner optical density of the liquid developer supported by the latent image carrier after development and before squeezing is then detected by a first optical density detector. The toner optical density of the liquid developer supported by the latent image carrier after squeezing is detected by a second optical density detector. A control unit then controls (adjusts) the developing bias based on the toner optical density detected by the first and second optical density detectors. Therefore, the force with which the liquid developer is squeezed off does not change, yet the toner optical density in the image portion of the latent image carrier where a latent image has been developed after squeezing and the toner optical density in the non-image portion of the latent image carrier where the latent image has not been developed can be controlled (adjusted) to the desired target optical density. Movement of toner particles from the latent image carrier to the squeezing member can thus be suppressed. Therefore, the amount of toner particles in the liquid pool can be reduced even when a liquid pool developed at the entrance to the squeeze nip. This can prevent re-attachment (re-development) of toner particles from the squeezing member on the latent image carrier, and can ensure uniform or nearly uniform image density across all areas of the image. As a result, uniformity of image quality can be improved.

Also provided is a first optical density detector for measuring the toner optical density in the liquid developer supported by the latent image carrier after development but before squeezing, and a second optical density detector for measuring the toner optical density in the liquid developer supported by the latent image carrier after squeezing. These can ensure uniformity of toner optical density in the liquid developer supported by the latent image carrier after development, and uniformity of toner optical density in the liquid developer supported by the latent image carrier after squeezing. As a result, the occurrence of image defects can be more effectively suppressed.

### BRIEF DESCRIPTION OF THE DRAWINGS

FIG. 1 is a view partially and schematically showing a portion of the image forming apparatus using the image forming method in an embodiment of the invention;

FIG. 2 is a view used to explain the occurrence of a liquid pool;

FIG. 3 is a view showing the relationship between the travel by the photoreceptor and the size of the liquid pool;

FIG. 4 is a view used to explain the re-attachment (re-development) of the toner particles in the liquid pool to the photoreceptor;

FIG. 5 is a view used to explain the uneven optical density of toner in an image;

FIG. 6 is a view used to explain the toner particles in the squeeze nip region of the photoreceptor and the squeeze roller;

FIG. 7 is a view used to explain how the toner optical density is controlled in a liquid developer;

FIG. 8A is a view showing the toner optical density before a patch pattern is squeezed, and B a view showing the toner optical density after the patch pattern has been squeezed;

FIG. 9 is a view used to explain the change in toner optical density in an image;

FIG. 10 is a view showing the maximum optical density unevenness relative to fog density after development;

FIG. 11 is a view showing the fog density relative to the developing bias;

FIG. 12 is a view showing the effective region of the developing bias in which the optical density is relatively constant;

FIG. 13 is a view used to explain developing bias control relative to the change in fog density;

FIG. 14 is a view showing the developing bias region in which the maximum optical density unevenness hardly occurs at all;

FIG. 15 is a view similar to FIG. 7 showing the second embodiment of the invention;

FIG. 16 is a view used to explain the charging of the toner particles supported by the developing roller in the second embodiment;

FIG. 17 is a view used to explain the toner particles in the squeeze nip region of the photoreceptor and the squeeze roller in the second embodiment;

FIG. 18 is a view showing the relationship between the pre-charging of the toner particles and fog density;

FIG. 19 is a view showing the effective region for the developing bias in which the optical density in the second embodiment is relatively constant;

FIG. 20 is a view used to explain the control of pre-charging relative to the change in fog density;

FIG. 21 is a view showing the pre-charging range in which the maximum optical density unevenness hardly occurs at all;

FIG. 22 is a view similar to FIG. 7 showing the third embodiment of the invention;

FIG. 23 is a view showing the effective region for the developing bias in which the optical density in the third embodiment is relatively constant; and

FIG. 24 is a view showing the effective region for the pre-charge in which the optical density in the third embodiment is relatively constant.

### DETAILED DESCRIPTION OF EXEMPLARY EMBODIMENTS

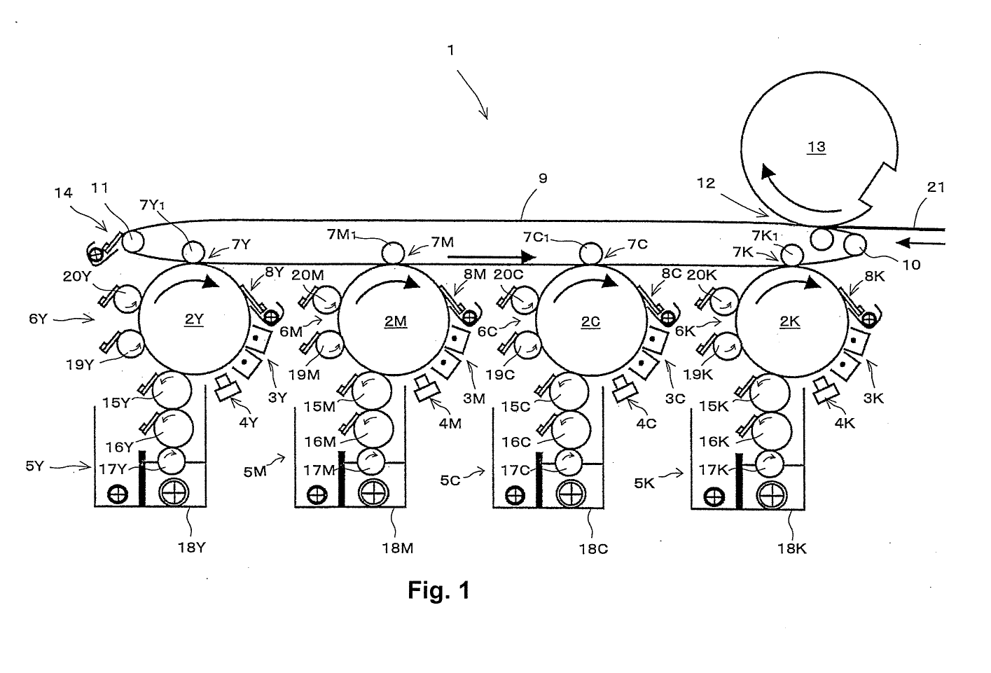

The following is a description of embodiments of the invention made with reference to the accompanying drawings. FIG. 1 is a view partially and schematically showing the image forming apparatus using in the first embodiment of the invention. An image forming apparatus 1 in the first embodiment forms images using a liquid developer containing a toner and a carrier liquid. As shown in FIG. 1, the image forming apparatus 1 in this embodiment is provided with photoreceptors 2Y, 2M, 2C, 2K arranged in tandem, which serve as the latent image carriers for supporting yellow (Y), magenta (M), cyan (C) and black (K) latent images. Here, in the case of photoreceptors 2Y, 2M, 2C, and 2K, 2Y denotes the photoreceptor for yellow, 2M denotes the photoreceptor for magenta, 2C denotes the photoreceptor for cyan, and 2K denotes the photoreceptor for black. The same applies for all other members, where Y, M, C, and K are appended to the reference numerals of members to denote members for the various colors. In the embodiment shown in FIG. 1, the photoreceptors 2Y, 2M, 2C, and 2K are photosensitive drums. However, the photoreceptors 2Y, 2M, 2C, and 2K can also take the form of an endless belt.

During operation, the photoreceptors 2Y, 2M, 2C, 2K all rotate in the clockwise direction as indicated by the arrows in FIG. 1. Charging units 3Y, 3M, 3C, 3K are provided, respectively, on the periphery of the photoreceptors 2Y, 2M, 2C, 2K. Also provided, respectively, on the periphery of the photoreceptors 2Y, 2M, 2C, 2K in sequential order with respect to the rotational direction of the photoreceptors 2Y, 2M, 2C, 2K after the charging units 3Y, 3M, 3C, 3K are exposure units 4Y, 4M, 4C, 4K, developing units 5Y, 5M, 5C, 5K, photoreceptor squeezing units 6Y, 6M, 6C, 6K, primary transfer units 7Y, 7M, 7C, 7K, and photoreceptor cleaning units 8Y, 8M, 8C, 8K. After the primary transfer, the photoreceptors 2Y, 2M, 2C, 2K are neutralized by neutralizing units not shown in the drawing. These photoreceptors 2Y, 2M, 2C, 2K; charging units 3Y, 3M, 3C, 3K; exposure units 4Y, 4M, 4C, 4K; developing units 5Y, 5M, 5C, 5K; photoreceptor squeezing units 6Y, 6M, 6C, 6K; primary transfer units 7Y, 7M, 7C, 7K; photoreceptor cleaning units 8Y, 8M, 8C, 8K; and neutralizing units constitute, respectively, the various image forming units in the image forming apparatus 1 of the first embodiment.

The image forming apparatus 1 is also provided with an endless intermediate transfer belt 9. This intermediate transfer belt 9 is arranged above the photoreceptors 2Y, 2M, 2C, 2K. This intermediate transfer belt 9 can come into separable contact with the photoreceptors 2Y, 2M, 2C, 2K at the various primary transfer units 7Y, 7M, 7C, 7K using primary transfer rollers 7Y1, 7M1, 7C1, 7K1.

While not shown in the drawing, the intermediate transfer belt 9 is a relatively soft elastic belt with a three-layer structure composed of a flexible base material such as a resin, an elastic layer such as rubber formed on the surface of the base material, and a surface layer formed on the surface of the elastic layer. As shall be apparent, the composition of the belt is not limited to this embodiment. The intermediate transfer belt 9 is wound around an intermediate transfer belt drive roller 10 to which the driving force of a motor not shown in the drawing is transmitted, and an intermediate transfer belt tension roller 11. The intermediate transfer belt 9 rotates under tension in the direction of the arrow (counterclockwise in FIG. 1). The order of arrangement for the members such as the photoreceptors corresponding to the various colors Y, M, C, K is not limited to the order shown in FIG. 1. They can be arranged in any order desired.

A secondary transfer unit 12 is provided on the intermediate transfer belt drive roller 10 side of the intermediate transfer belt 9. The secondary transfer unit 12 has a secondary transfer roller 13. The secondary transfer roller 13 rotates in the direction of the arrow shown in FIG. 1 (clockwise in FIG. 1). This secondary transfer roller 13 comes into contact with the intermediate transfer belt 9 wound around the intermediate transfer belt drive roller 10 to form a secondary transfer nip. Also, an intermediate transfer belt cleaning unit 14 is provided on the intermediate transfer belt tension roller 11 side of the intermediate transfer belt 9.

The developing units 5Y, 5M, 5C, 5K each have developing rollers 15Y, 15M, 15C, 15K serving as developing members for contacting the photoreceptors 2Y, 2M, 2C, 2K and forming developing nips, intermediate rollers 16Y, 16M, 16C, 16K for contacting the developing rollers 15Y, 15M, 15C, 15K, supply rollers (anilox rollers) 17Y, 17M, 17C, 17K for contacting the intermediate rollers 16Y, 16M, 16C, 16K, and developer containers 18Y, 18M, 18C, 18K for containing the liquid developer. The supply rollers 17Y, 17M, 17C, 17K and the intermediate rollers 16Y, 16M, 16C, 16K rotate in the direction of the arrows shown in FIG. 1.

In other words, the photoreceptors 2Y, 2M, 2C, 2K and the developing rollers 15Y, 15M, 15C, 15K rotate with each other at equal circumferential velocities. In this way, the latent images formed on the photoreceptors 2Y, 2M, 2C, 2K can be developed reliably using the liquid developer supplied from the developing rollers 15Y, 15M, 15C, 15K. The developing rollers 15Y, 15M, 15C, 15K and the intermediate rollers 16Y, 16M, 16C, 16K rotate in the same direction (but in opposite direction with respect to circumferential velocity) (referred to below as counter rotation). The intermediate rollers 16Y, 16M, 16C, 16K and the supply rollers 17Y, 17M, 17C, 17K rotate with each other. In this way, the liquid developers for the various colors stored in the developer containers 18Y, 18M, 18C, 18K are supplied to the corresponding developing rollers 15Y, 15M, 15C, 15K. As a result, a uniform thin film of liquid developer is formed at a predetermined thickness (e.g., 4-8 μM) on the developing rollers 15Y, 15M, 15C, 15K.

The photoreceptor squeezing units 6Y, 6M, 6C, 6K have a first photoreceptor squeezing roller 19Y, 19M, 19C, 19K serving as the squeezing member for contacting the photoreceptors 2Y, 2M, 2C, 2K and forming a first squeezing nip, and a second photoreceptor squeezing roller 20Y, 20M, 20C, 20K for contacting the photoreceptors 2Y, 2M, 2C, 2K and forming a second squeezing nip. The photoreceptors 2Y, 2M, 2C, 2K, the first photoreceptor squeeze rollers 19Y, 19M, 19C, 19K, and the second photoreceptor squeeze rollers 20Y, 20M, 20C, 20K rotate with each other at equal circumferential velocities. The toner images developed on the photoreceptors 2Y, 2M, 2C, 2K by the developing units 5Y, 5M, 5C, 5K are thus not disturbed by the first photoreceptor squeeze rollers 19Y, 19M, 19C, 19K, and the second photoreceptor squeeze rollers 20Y, 20M, 20C, 20K.

The following is a description of the basic image forming operations performed by the image forming apparatus 1 in the first embodiment. When an image command is inputted, the various image forming units begin operating. The photoreceptor 2Y for yellow is charged uniformly by the charging unit 3Y, and a latent image for yellow is rendered (formed) on the photoreceptor 2Y by the exposure unit 4Y. The latent image for yellow on the photoreceptor 2Y is developed with the yellow toner supplied to the developing unit 5Y by the developing roller 15Y. At this time, a developing bias is applied to the developing roller 15Y. The developed yellow toner image is transported towards the primary transfer unit 7Y by rotating the photoreceptor 2Y. In the meantime, a predetermined amount of carrier liquid and the fogging toner in the non-image portion of the photoreceptor 2Y where the latent image has not been developed are removed by the photoreceptor squeezing unit 6Y. At this time, a squeeze bias is applied to the first and second squeeze rollers 19Y, 20Y in the photoreceptor squeezing unit 6Y. The toner images for magenta, cyan, and black are formed on their respective photoreceptors 2M, 2C, 2K, and transported towards their primary transfer units 7M, 7C, 7K in the same way.

Then, the toner image for yellow transported to the primary transfer unit 7Y for yellow is transferred to the intermediate transfer belt 9. Next, the toner image for magenta transported to the primary transfer unit 7M for magenta is transferred by the primary transfer unit 7M to the intermediate transfer belt 9 so as to be superimposed on the yellow toner image. Similarly, the toner images for cyan and black transported to their primary transfer units 7C, 7K are successively transferred by their primary transfer units 7C, 7K to the intermediate transfer belt 9 so that the various colors are superimposed on each other. In this way, a full color toner image is formed on the intermediate transfer belt 9.

The full color toner image supported by the intermediate transfer belt 9 is transferred by the secondary transfer unit 12 to a transfer medium 21 such as paper that has been transported. The full color toner image transferred to the transfer medium 21 is then fixed by a fixing unit not shown in the drawing. A full color image is thus formed on a transfer medium 21. Because the other basic configurational elements and the other basic image forming operations of the image forming apparatus 1 in the first embodiment are similar to those performed by the same type of prior art image forming apparatus using a liquid developer, further explanation has been omitted.

In the image forming apparatus 1 of the first embodiment, the toner in the liquid developer supported by the developing rollers 5Y, 5M, 5C, 5K is compressed by the charging bias, and the optical density of the toner supplied to the photoreceptors 2Y, 2M, 2C, 2K is controlled by controlling the circumferential velocities of the developing rollers 15Y, 15M, 15C, 15K, the intermediate rollers 16Y, 16M, 16C, 16K, and the supply rollers 17Y, 17M, 17C, 17K.

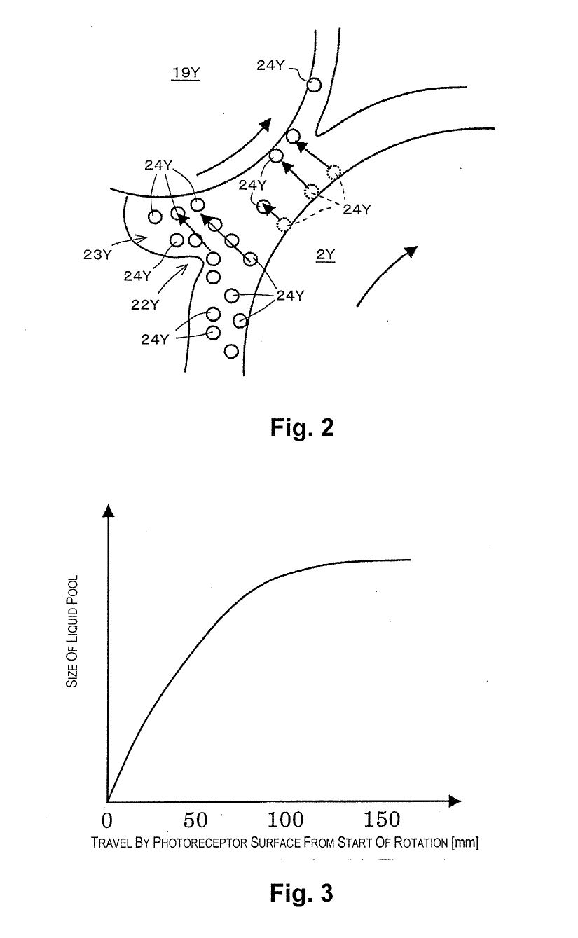

However, as shown in FIG. 2, for example, a liquid pool 23Y of liquid developer forms at the nip entrance 22Y to the squeeze nip for the photoreceptor 2Y and the first photoreceptor squeeze roller 19Y. As shown in FIG. 3, the size of the liquid pool 23Y grows larger as the travel by the surface of the photoreceptor 2Y increases from the start of rotation by the photoreceptor 2Y and the first photoreceptor squeeze roller 19Y. However, the growth slows once the travel by the surface of the photoreceptor 2Y reaches a certain amount. This causes the toner particles 24Y functioning as fog in the non-image portion of the photoreceptor 2Y to move to the first photoreceptor squeeze roller 19Y side at the nip entrance 22Y as indicated by the arrow in FIG. 2. Because the carrier liquid attracted to the movement of the toner particles 24Y also moves from the photoreceptor 2Y side to the first photoreceptor squeeze roller 19Y side at this time, a liquid pool 23Y forms, and the rotation of the photoreceptor 2Y increases the size of this liquid pool. The toner particles 24Y leftover from the development of the photoreceptor 2Y by the developing roller 15Y are retained by this liquid pool 23Y.

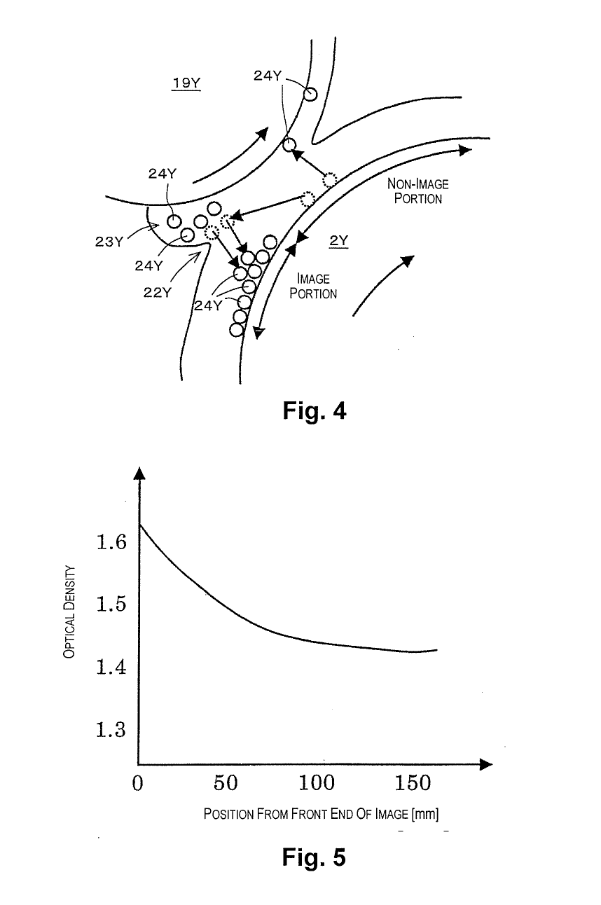

The squeeze bias applied to the first photoreceptor squeeze roller 19Y is set between the first photoreceptor squeeze roller 19Y and the image portion and non-image portion of the photoreceptor 2Y where the latent image is and is not formed. As shown in FIG. 4, the surface potential of the image portion of the photoreceptor 2Y (e.g., 50 V), the surface potential of the non-image portion of the photoreceptor (e.g., 600 V), and the surface potential of the first photoreceptor squeeze roller 19Y (e.g., 400 V) are all different. As a result, the toner particles 24Y in the liquid pool 23Y move towards the image portion side of the photoreceptor 2Y, and are re-attached (re-developed) in the image portion of the photoreceptor 2Y. As a result, differences in optical density occur in the image, in which the optical density at the front end of the image is greater, as shown in FIG. 5. The image density shown in FIG. 5 is for a solid image.

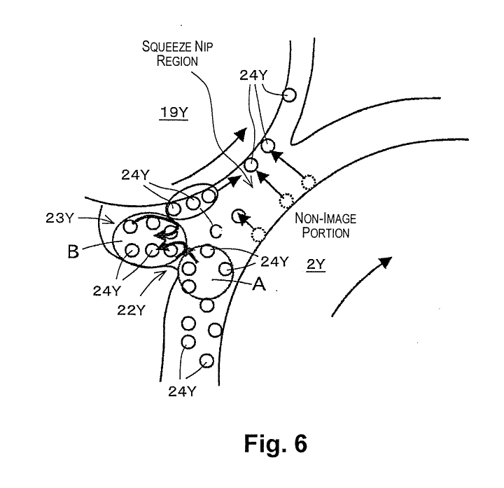

In order to prevent re-development of toner particles from the first photoreceptor squeeze roller 19Y in the image portion of the photoreceptor 2Y, toner particles 24Y cannot be retained in the liquid pool 23Y. This would effectively reduce fogging in the non-image portion of the photoreceptor 2Y after development, and would reduce the movement of toner particles in the non-image portion to the first photoreceptor squeeze roller 19Y. As shown in FIG. 6, the toner particles in the squeeze nip region of the photoreceptor 2Y and the first photoreceptor squeeze roller 19Y can be divided into toner particles A that have moved from the non-image portion of the photoreceptor 2Y to the first photoreceptor squeeze roller 19Y, toner particles B that are convected in the vortex inside the liquid pool 23Y, and toner particles C that have been recovered by the first photoreceptor squeeze roller 19Y. Considering that there is an inflow and outflow of toner in the liquid pool 23Y, in order to minimize the retention of toner particles in the liquid pool 23Y, the amount of toner particle A has to be reduced as much as possible, the amount of toner particle C has to be increased as much as possible, or both have to be achieved.

Therefore, in the image forming apparatus 1 of the first embodiment, the developing bias applied to the developing rollers 5Y, 5M, 5C, 5K is controlled (adjusted) based on the toner optical density on the photoreceptors 2Y, 2M, 2C, 2K before the liquid developer supported by the photoreceptors 2Y, 2M, 2C, 2K has been squeezed by the photoreceptor squeezing rollers 6Y, 6M, 6C, 6K, and based on the toner optical density on the photoreceptors 2Y, 2M, 2C, 2K after the liquid developer has been squeezed. In this way, the amount of toner supplied from the developing rollers 5Y, 5M, 5C, 5K to the photoreceptors 2Y, 2M, 2C, 2K can be controlled. Thus, the amount of toner particles A is controlled, and the optical density of the toner supplied to the photoreceptors 2Y, 2M, 2C, 2K is controlled.

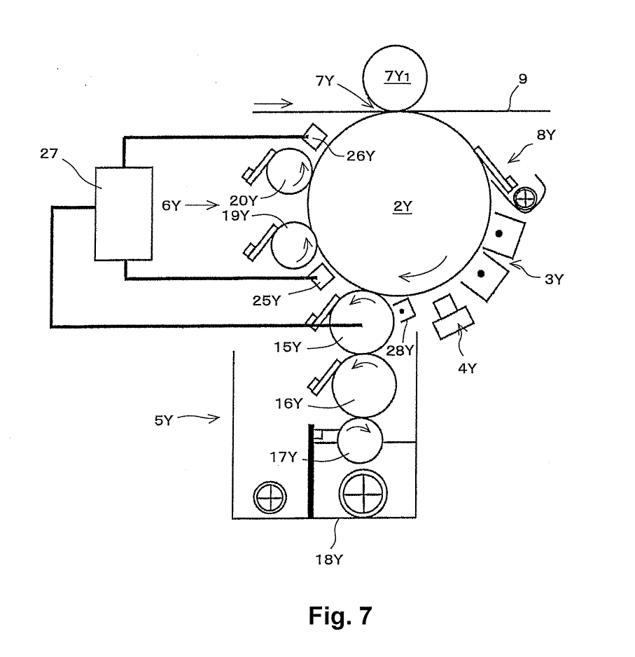

FIG. 7 is a view used to explain how the toner optical density is controlled in the liquid developer for yellow. The toner optical density for the other colors is controlled in the same manner that the toner optical density is controlled for yellow. Therefore, control of the toner optical density for yellow will be explained, and explanation of the other colors will be omitted. For ease of explanation, the compositional members for the colors other than yellow use M, C or K instead of the Y in the configurational members for yellow; however, this is not shown in the drawing.

As shown in FIG. 7, the image forming apparatus 1 in the first embodiment has a first optical density sensor 25Y composed of an optical sensor serving as the first optical density detector (first toner optical density detector) for measuring (detecting) the first toner optical density of the toner supported by the photoreceptor 2Y between the developing roller 15Y and the first photoreceptor squeeze roller 19Y, and a second optical density sensor 26Y composed of an optical sensor serving as the second optical density detector (second toner optical density detector) for measuring (detecting) the second toner optical density of the toner supported by the photoreceptor 2Y between the second photoreceptor squeeze roller 20Y and the primary transfer unit 7Y. The first and second optical density sensors 25Y, 26Y are connected to the control unit 27 in the image forming apparatus 1. The developing roller 15Y is also connected to the control unit 27, and a developing bias is applied to the developing roller 15Y from the control unit 27 during development. FIG. 7 shows the first and second optical density sensors 25Y, 26Y connected to the control unit 27. However, the connection of the other configurational members of the image forming apparatus 1 controlled by the control unit 27 to the control unit 27 is not shown. The image forming apparatus 1 in the first embodiment also has a charging unit 28Y for compressing developer, which compresses the toner supported by the developing roller 15Y in the developing unit 5Y using the charge bias.

In the image forming apparatus 1 of the first embodiment, the developing bias for the developing roller 15Y is controlled based on the toner optical density of the photoreceptor 2Y detected by the first and second optical density sensors 25Y, 26Y. Thus, the amount of toner supplied from the developing roller 15Y to the photoreceptor 2Y is controlled, and the toner optical density of the toner supported by the photoreceptor 2Y is controlled. The following is a description of the method used to control the toner optical density on the photoreceptor 2Y in the first embodiment.

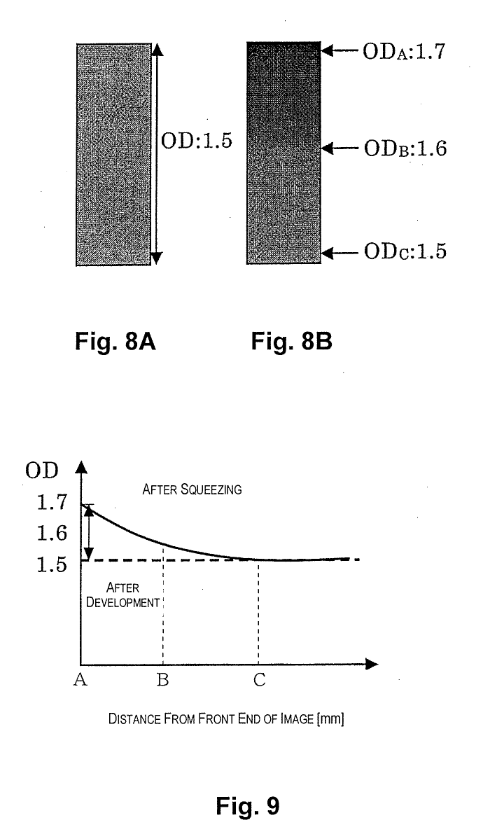

In the control method for the optical density of the toner on the photoreceptor 2Y in the image forming apparatus 1 of the first embodiment, first, the patch pattern (solid image or half image) shown in FIG. 8a is formed on the photoreceptor 2Y. This patch pattern is formed in the image portion of the photoreceptor 2Y between a transfer medium 21 and the next transfer medium 21. After the patch pattern has been formed on the photoreceptor 2Y by the developing unit 5Y and before it has been squeezed by the photoreceptor squeezing unit 6, the toner optical density is uniform or nearly uniform across all areas of the patch pattern as shown in FIG. 8a (in the example in this drawing, the toner optical density has an OD value of 1.5). When the toner optical density control in the first embodiment is not performed, after the patch pattern has been squeezed by the photoreceptor squeezing unit 6Y, the toner optical density, as shown in FIG. 8 and FIG. 9, is greater at the front end of the patch pattern (the upper end in FIG. 8b), and becomes gradually smaller towards the rear end of the patch pattern (the lower end in FIG. 8b). In other words, optical density varies between the front end and the rear end of the patch pattern (in the example in this drawing, the toner optical density has an ODA value of 1.7 at the front end of the patch pattern, an ODB value of 1.6 in the middle of the patch pattern, and an ODC value of 1.5 at the rear end of the patch pattern; i.e., there is a maximum optical density unevenness with an OD value of 0.2 between the front end and the rear end of the patch pattern).

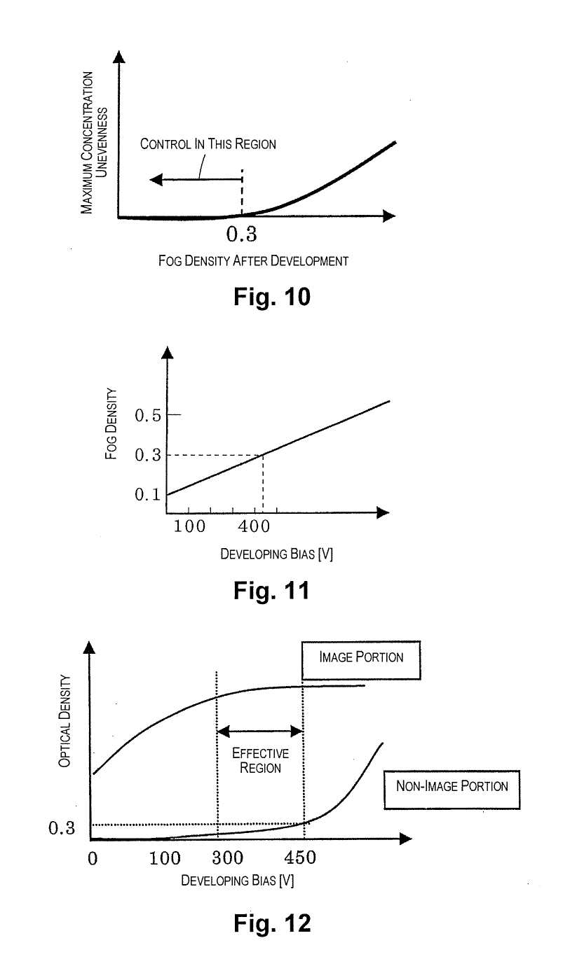

This maximum optical density unevenness depends on the toner optical density of the patch pattern after development and before squeezing (fog optical density after development) as shown in FIG. 10. In other words, the maximum optical density unevenness is nearly 0 and there is hardly any optical density unevenness in regions having a fog optical density after development that is less than a predetermined optical density (an OD value of 0.3 in the example shown in this drawing). When the fog optical density after development exceeds the predetermined optical density, the maximum optical density unevenness gradually increases.

Therefore, in the toner optical density control method for the image forming apparatus in the first embodiment, the toner optical density in the non-image portion and the patch portion (image portion) of the photoreceptor 2Y before squeezing by the first photoreceptor squeezing roller 19Y are measured by the first optical density sensor 25Y. Also, the toner optical density in the non-image portion and the patch portion of the photoreceptor 2Y after squeezing by the second photoreceptor squeezing roller 20Y are measured by the second optical density sensor 26Y. Then, the developing bias is controlled by the control unit 27 based on the toner optical density measured by the first and second optical density sensors 25Y, 26Y.

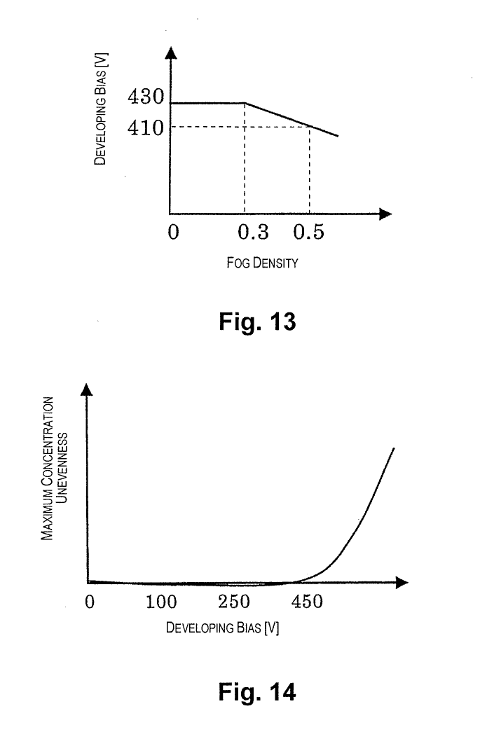

In the process characteristics when the developing bias is changed, as shown in FIG. 11, the fog optical density increases as the developing bias rises. Therefore, when the fog optical density during normal image formation has increased, the control unit 27 can perform a control to lower the developing bias applied to the developing roller 15Y. For example, in a case shown in FIG. 12, where the effective range for the developing bias used to keep the toner optical density in the image portion and the non-image portion of the photoreceptor fairly constant is from 300 V to 450 V, when the fog optical density during normal image formation has increased from an OD value of 0.3 to 0.5 as shown in FIG. 13, the control unit 27 lowers the developing bias applied to the developing roller 15Y from 430 V to 410 V before the fog optical density increases. Because the developing bias set to 410 V is within the effective range mentioned above, a desired optical density can be realized for both the toner optical density in the image portion and the toner optical density in the non-image portion. The occurrence of optical density unevenness is also suppressed by setting the developing bias at a value of 450 V or less as shown in FIG. 14. In other words, the occurrence of optical density unevenness can be suppressed by controlling the developing bias within the effective region for the developing bias mentioned above.

In the image forming apparatus 1 of the first embodiment, the developing bias is controlled by the control unit 27 based on the toner optical density in the non-image portion and the patch pattern portion of the photoreceptors 2Y, 2M, 2C, 2K before being squeezed by the first photoreceptor squeeze rollers 19Y, 19M, 19C, 19K, and based on the toner optical density in the non-image portion and the patch pattern portion of the photoreceptors 2Y, 2M, 2C, 2K after being squeezed by the second photoreceptor squeeze rollers 20Y, 20M, 20C, 20K. In other words, the supply of toner from the developing rollers 15Y, 15M, 15C, 15K to the photoreceptors 2Y, 2M, 2C, 2K is controlled. Therefore, the removal force for the liquid developer from squeezing does not change as in the prior art, yet the toner optical density in the image portion and the non-image portion of the photoreceptors 2Y, 2M, 2C, 2K after squeezing can be controlled to obtain the desired target optical density. In this way, movement of toner particles from the photoreceptors 2Y, 2M, 2C, 2K to the first photoreceptor squeezing rollers 19Y, 19M, 19C, 19K and the second photoreceptor squeezing rollers 20Y, 20M, 20C, 20K can be suppressed. Therefore, the amount of toner particles in the liquid pool can be reduced even when a liquid pool occurs in the entrance to the squeeze nip. This prevents re-development of toner particles on the photoreceptors from the first photoreceptor squeezing rollers 19Y, 19M, 19C, 19K and the second photoreceptor squeezing rollers 20Y, 20M, 20C, 20K, and the image density is uniform or nearly uniform across all areas of the image formed on the transfer medium 21. As a result, the uniformity of image quality can be improved.

Also provided are first optical density sensors 25Y, 25M, 25C, 25K for measuring the toner optical density of the photoreceptors 2Y, 2M, 2C, 2K after development and before squeezing, and second optical density sensors 26Y, 26M, 26C, 26K for measuring the toner optical density of the photoreceptors 2Y, 2M, 2C, 2K after squeezing. In this way, the uniformity of the toner optical density on the photoreceptors 2Y, 2M, 2C, 2K after development, and the uniformity of the toner optical density on the photoreceptors 2Y, 2M, 2C, 2K after squeezing can be ensured. As a result, the occurrence of print quality defects can be more effectively suppressed.

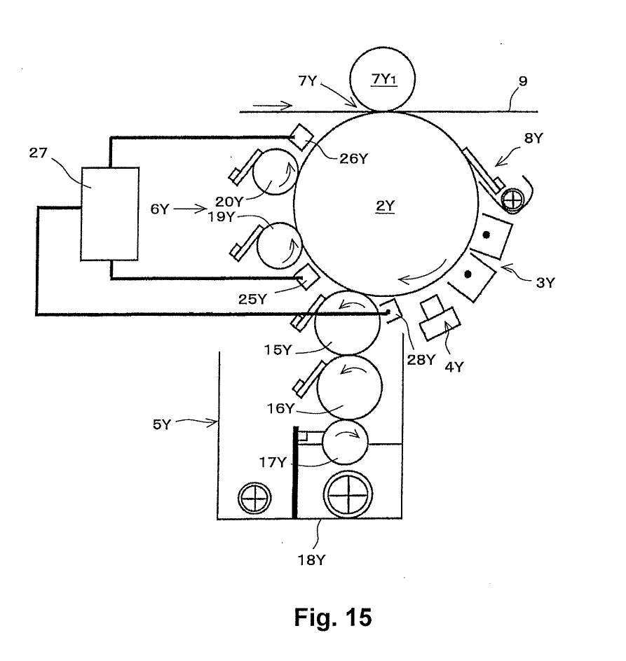

FIG. 15 is a view similar to FIG. 7 showing the second embodiment of the invention. In the second embodiment, the toner optical density for the other colors is controlled in the same manner as the toner optical density for yellow in the first embodiment.

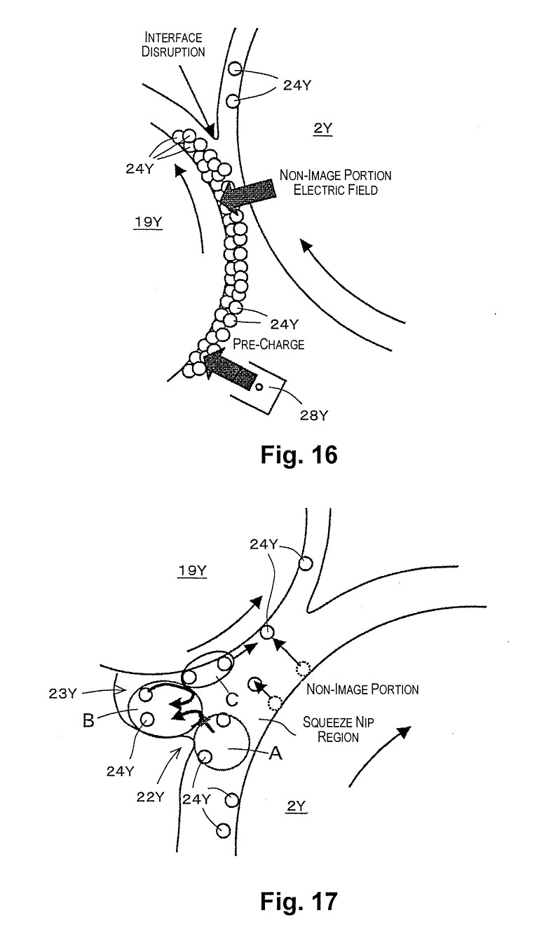

In the first embodiment described above, the optical density of the toner supplied to the photoreceptor 2Y is controlled by controlling the developing bias. By contract, in the image forming apparatus 1 of the second embodiment shown in FIG. 15, a developer charging bias is applied from the charging unit for developer compression 28Y to the liquid developer supported by the developing roller 5Y based on the toner optical density on the photoreceptor 2Y before the liquid developer supported by the photoreceptor 2Y has been squeezed by the photoreceptor squeezing unit 6Y and based on the toner optical density on the photoreceptor 2Y after the liquid developer has been squeezed. This pre-charges (charges) and compresses the toner supported by the developing roller 5Y. In this case, as shown in FIG. 16, the toner particles 24Y can be pushed to the developing roller 15Y side by strengthening the pre-charge for the toner on the developing roller 5Y. In this way, the amount of toner supplied from the developing roller 15Y to the photoreceptor 2Y can be controlled. This makes it much less likely that fogging will occur when the interface disruption occurs in the liquid developer at the nip exit between the photoreceptor 2Y and the developing roller 15Y. Because the number of toner particles A moving from the non-image portion of the photoreceptor 2Y to the first photoreceptor squeezing roller 19Y is reduced, as shown in FIG. 17, the number of toner particles B remaining in the liquid pool 23Y is also reduced. Thus, the amount of toner supplied to the photoreceptor 2Y can be controlled, and the optical density of the toner supported by the photoreceptor 2Y can be controlled.

In the image forming apparatus 1 of the second embodiment, the pre-charge (charge bias of the charging unit for developer compression 28Y: V) of the charging unit for developer compression 28Y is controlled by the control unit 27 based on the toner optical density of the photoreceptor 2Y detected by the first and second optical density sensors 25Y, 26Y. In this way, the optical density of the toner supported by the photoreceptor 2Y can be controlled. The following is a description of the method used to control the optical density of the toner on the photoreceptor 2Y in the second embodiment.

In the control method for the optical density of the toner on the photoreceptor 2Y in the image forming apparatus 1 of the second embodiment, first, as in the first embodiment, the patch pattern (solid image or half image) shown in FIG. 8a is formed on the photoreceptor 2Y. Then, as in the first embodiment, the pre-charge of the charge unit for developer compression 28Y is controlled based on the toner optical density of the patch pattern before squeezing and on the toner optical density of the patch pattern after squeezing.

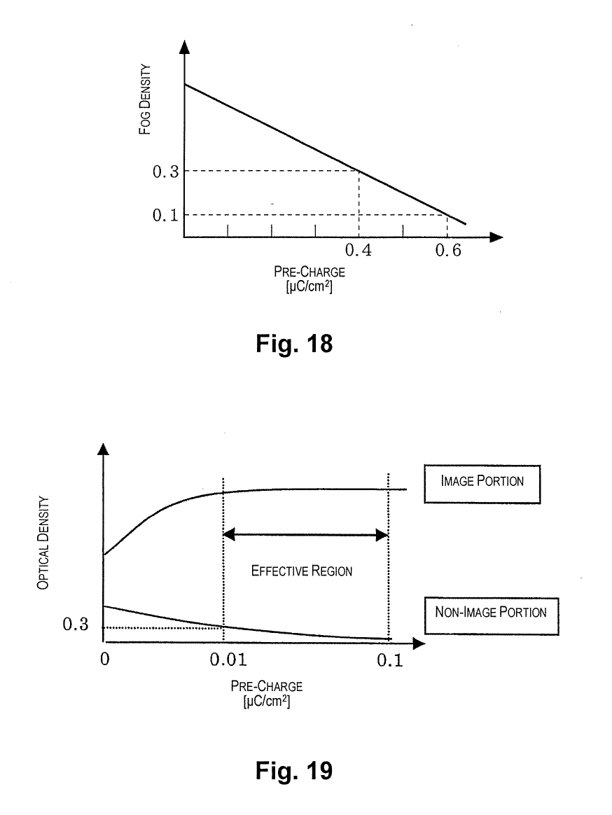

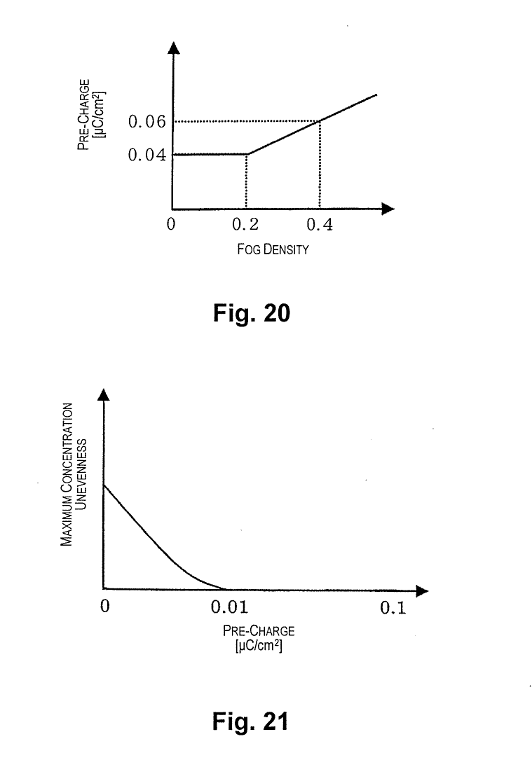

As shown in FIG. 18, the process characteristics when the pre-charge for the toner is changed by the charge unit for developer compression 28Y is such that the fog optical density increases as the pre-charge decreases. Therefore, when the fog optical density has increased during normal image formation, the control unit 27 controls the charge bias of the charge unit for developer compression 28Y to increase the pre-charge. For example, as shown in FIG. 19, in a situation where the effective range for the pre-charge (the charge amount of the charge unit for developer compression 28Y) in the image portion and non-image portion of the photoreceptor is from 0.01 μC/CM2 to 0.1 μC/CM2, when the fog optical density during normal image formation increases from an OD value of 0.2 to 0.4 as shown in FIG. 20, the control unit 27 increases the pre-charge by the charge unit for developer compression 28Y from 0.04 μC/CM2 to 0.06 μC/CM2 before the fog optical density increases. Because the pre-charge set to 0.06 μC/CM2 is within the effective range mentioned above, a desired optical density can be realized for both the toner optical density in the image portion and the toner optical density in the non-image portion. Also, as shown in FIG. 21, by setting the pre-charge at 0.01 μC/CM2, the occurrence of optical density unevenness can be suppressed. In other words, the occurrence of optical density unevenness can be suppressed by keeping the pre-charge for the toner supported by the developing roller 15Y within the pre-charge effective range mentioned above.

The other configurational elements and the other operational effects of the image forming apparatus 1 in the second embodiment are the same as those of the first embodiment mentioned above. However, instead of using a pre-charge to push the toner particles to the developing roller 15Y side, increasing the electric field in the non-image portion of the photoreceptor 2Y can be used to push the toner particles to the developing roller 15Y side as shown in FIG. 16.

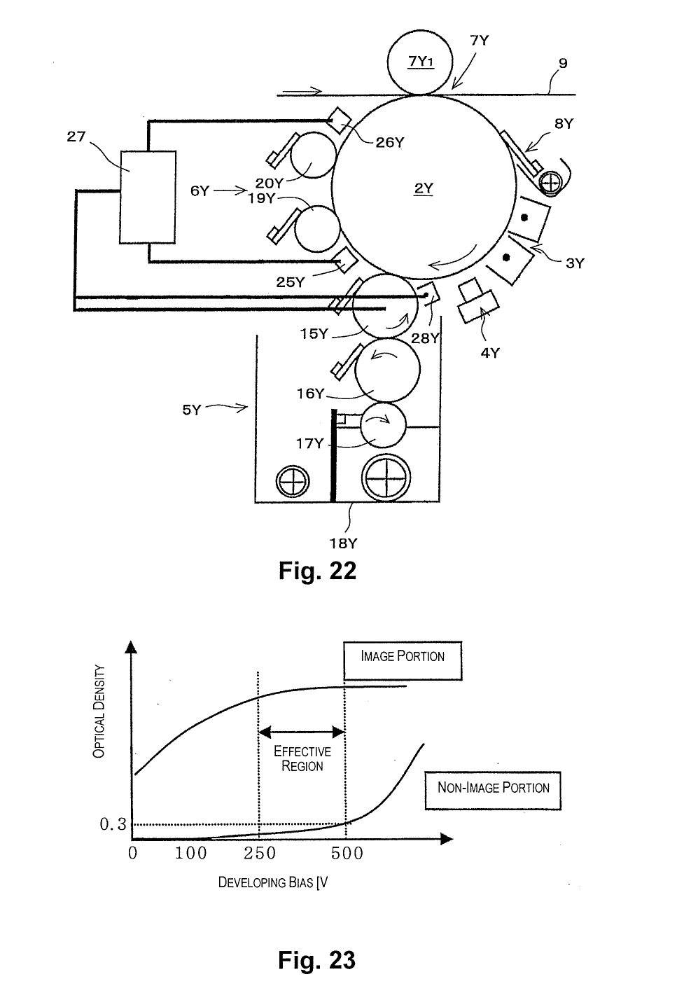

FIG. 22 is a view similar to FIG. 7 showing the third embodiment of the invention. In the third embodiment, the toner optical density for the other colors is controlled in the same manner as the toner optical density for yellow in the first embodiment.

As shown in FIG. 22, the image forming apparatus I in the third embodiment controls the optical density of the toner on the photoreceptors 2Y, 2M, 2C, 2K by controlling the developing bias in the same manner as the first embodiment and by controlling the pre-charge in the same manner as the second embodiment.

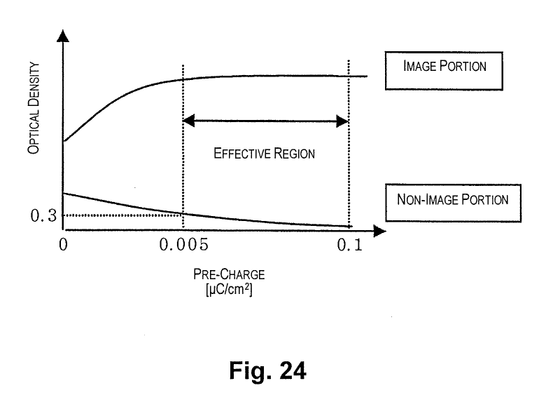

In the third embodiment, the effective region for the developing bias in the image portion and the non-image portion of the photoreceptors is from 250 V to 500 V as shown in FIG. 23, and the effective region for the pre-charge in the image portion and the non-image portion of the photoreceptors is from 0.005 μC/CM2 to 0.1 μC/CM2 as shown in FIG. 24. By controlling the developing bias within the effective range mentioned above and by controlling the pre-charge of the toner supported by the development roller 15Y within the effective range mentioned above, the occurrence of optical density unevenness can be suppressed. The other aspects of the configuration and the other operational effects of the image forming apparatus in the third embodiment are the same as those in the first embodiment described above.

What is claimed is:

1. An image forming apparatus comprising:
a latent image carrier that carries a latent image;
a charging unit that charges the latent image carrier;
a developing unit that develops the latent image carried by the latent image carrier, the developing unit having a developing member that supports a liquid developer including a toner and a carrier liquid, and the developing member having a developing bias applied thereto;
a first optical density detector that detects a toner optical density in the liquid developer supported by the latent image carrier and developed by the developing member;
a squeeze unit that squeezes the latent image carrier, the squeeze unit having a squeeze member that makes contact with the latent image carrier for which toner optical density has been detected by the first optical density detector; and
a second optical density detector that detects a toner optical density of the liquid developer supported by the latent image carrier and squeezed by the squeeze member.

2. The image forming apparatus of claim 1, further comprising;
a control unit that controls the developing bias based on the toner optical density detected by the first optical density detector, and the toner optical density detected by the second optical density detector.

3. The image forming apparatus of claim 1, wherein
the developing unit has a developer charging unit that applies a developer charge bias that causes the liquid developer supported by the developing member to be charged; and wherein the controller controls the developer charge bias based on the toner optical density detected by the first optical density detector, and the toner optical density detected by the second optical density detector.

4. The image forming apparatus of claim 1, wherein
the first optical density detector detects the toner optical density at a position on the latent image carrier at which the latent image has been formed by an exposure unit and the latent image has been developed by the developing member; and detects the toner optical density at a position on the latent image carrier at which the latent image has not been formed by the exposure unit.

5. An image forming method, comprising:
exposing a latent image carrier to light and forming a latent image;
developing the latent image using a developing member that supports a liquid developer including a toner and a carrier liquid, the developing member having a developing bias applied thereto;
having a first toner optical density detector detect a toner optical density of the liquid developer supported by the latent image carrier and developed by the developing member;
squeezing the latent image carrier detected by the first toner optical density detector; and
having a second toner optical density detector detect a toner optical density of the liquid developer supported by the squeezed latent image carrier.

6. The image forming method of claim 5, further comprising
adjusting the developing bias applied to the developing member based on the toner optical density detected by the first toner optical density detector, and the toner optical density detected by the second toner optical density detector; and applying the adjusted developing bias to the developing member and developing the latent image.

7. The image forming method of claim 5, wherein
the first toner optical density detector detecting the toner optical density of the image developed after the latent image has been formed, and detecting the toner optical density of the liquid developer supported at a position on the latent image carrier where the latent image has not been formed.

8. The image forming method of claim 7, comprising
the second toner optical density detector detecting the toner optical density of the image developed after the latent image has been formed, and detecting the toner optical density of the liquid developer supported at a position on the latent image carrier where the latent image has not been formed.
